(19) United States
(12) Patent Application Publication
(10) Pub. No.: US 2026/0346137 A1
(43) Pub. Date: Nov. 5, 2026

(54) METHOD FOR SWITCHING SKY BACKGROUND IN GAME, ELECTRONIC DEVICE AND STORAGE MEDIUM

(71) Applicant: NETEASE (HANGZHOU) NETWORK CO., LTD., Hangzhou, Zhejiang (CN)

(72) Inventors: Zanchen LI, Hangzhou, Zhejiang (CN); Zhiyi LI, Hangzhou, Zhejiang (CN)

(73) Assignee: NETEASE (HANGZHOU) NETWORK CO., LTD., Hangzhou, Zhejiang (CN)

(21) Appl. No.: 19/487,612

(22) PCT Filed: Jul. 13, 2023
(86) PCT No.: PCT/CN2023/107201

§ 371 Date: Nov. 25, 2025

(30) Foreign Application Priority Data
May 25, 2023 (CN) 202310602726.1

(51) Int. Cl. A63F 13/52; A63F 13/533

(52) U.S. Cl. CPC A63F 13/52; A63F 13/533

(57) ABSTRACT

A method for switching a sky background in a game is provided. The method includes: determining, in response to a sky background switching event, target sky background information and a switching parameter corresponding to the sky background switching event; and updating, based on the switching parameter, the sky background information corresponding to the game scene from current sky background information to the target sky background information, and dynamically displaying, within a graphical user interface provided by a terminal device, a dynamically-varying sky background of the game scene rendered during a process of updating the sky background information. The process of updating the sky background information is a process of updating the sky background information corresponding to the game scene from the current sky background information to the target sky background information.

### CROSS-REFERENCE TO RELATED APPLICATIONS

The present application is a U.S. National Stage of International Application No. PCT/CN2023/107201 filed on Jul. 13, 2023, which is based upon and claims priority to Chinese Patent Application No. 202310602726.1, filed on May 25, 2023, and entitled “Method and Device for Switching a Sky Background in a Game, and Electronic Device”, and the entire contents thereof are incorporated herein by reference.

### TECHNICAL FIELD

The present disclosure relates to the field of game interaction design technology, and more particularly, to a method and device for switching a sky background in a game and an electronic device.

### BACKGROUND

When a user displays his/her original content via an internet platform or shares the same with other users, background switching is often necessary in order to indicate a location change or enhance the mood. In the related art, a game scene is typically packaged with a skybox, and the background switching in the game scene is achieved through movement of the skybox. However, this method only permits the background switching under an editing mode of a game level, resulting in a poor player experience. Furthermore, as the skybox relies solely on motion mechanism during the switching, the resulting background switching appears rather monotonous, failing to meet player expectations.

### SUMMARY

An object of the present disclosure is to provide a method and device for switching a sky background in a game and an electronic device.

An aspect of the present disclosure provides a method for switching a sky background in a game, in which a graphical user interface is provided via a terminal device and displays a portion of a game scene and a sky background corresponding to the game scene, and the sky background is a background generated based on sky background information. The method includes: determining, in response to a sky background switching event, target sky background information and a switching parameter corresponding to the sky background switching event; and updating, based on the switching parameter, the sky background information corresponding to the game scene from current sky background information to the target sky background information, and dynamically displaying, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

An aspect of the present disclosure provides a device for switching a sky background in a game, in which a graphical user interface is provided via a terminal device and displays a scene view of a portion of a game scene and a sky background corresponding to the game scene, and the sky background is a background generated based on sky background information. The device includes: an information obtaining module, configured to determine, in response to a sky background switching event, target sky background information and a switching parameter corresponding to the sky background switching event; and a sky background switching module, configured to update, based on the switching parameter, sky background information corresponding to the game scene from current sky background information to the target sky background information, and dynamically display, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

An aspect of the present disclosure provides an electronic device including a processor and a memory, in which the memory stores machine-executable instructions executable by the processor, and the processor executes the machine-executable instructions to implement the method for switching the sky background in the game described above.

An aspect of the present disclosure provides a computer-readable storage medium having computer-executable instructions stored thereon that, when invoked and executed by a processor, cause the processor to implement the method for switching the sky background in the game described above.

Further features and advantages of the present disclosure will be described in the subsequent description. Alternatively, some features and advantages may be inferred or determined unambiguously from the specification, or may be ascertained through the implementation of the aforementioned technical solutions of the present disclosure.

To render the aforementioned objectives, features, and advantages of the present disclosure more readily apparent and comprehensible, a preferred embodiment is described in detail below with reference to the accompanying drawings.

### BRIEF DESCRIPTION OF THE DRAWINGS

FIG. 1 is a flowchart illustrating a method for switching a sky background in a game provided by an embodiment of the present disclosure;

FIG. 2 is a flowchart illustrating another method for switching a sky background in a game provided by an embodiment of the present disclosure;

FIG. 3 is a schematic diagram illustrating a method for updating a sky background based on a first switching mode provided by an embodiment of the present disclosure;

FIG. 4 is a schematic diagram illustrating a method for updating a sky background based on a second switching mode provided by an embodiment of the present disclosure;

FIG. 5 is a flowchart illustrating another method for switching a sky background in a game provided by an embodiment of the present disclosure;

FIG. 6 is a flowchart illustrating another method for switching a sky background in a game provided by an embodiment of the present disclosure;

FIG. 7 is a schematic diagram illustrating a parameter setting panel provided by an embodiment of the present disclosure;

FIG. 8 is a structural schematic diagram illustrating a device for switching a sky background in a game provided by an embodiment of the present disclosure; and

FIG. 9 is a structural schematic diagram of an electronic device provided by an embodiment of the present disclosure.

### DETAILED DESCRIPTION

Hereinafter, the technical solutions of the embodiments of the present disclosure are to be described clearly and completely with reference to the accompanying drawings, so as to make the objectives, technical solutions, and advantages of the embodiments of the present disclosure clearer. Apparently, the embodiments described are a portion instead of all of the embodiments of the present disclosure. Generally, components of the embodiments of the present disclosure described and illustrated in the accompanying drawings herein may be arranged and designed in various different configurations.

Therefore, the detailed description of the embodiments of the present disclosure provided in the accompanying drawings is not intended to limit the scope of the present disclosure as claimed, but merely represents selected embodiments of the present disclosure. All other embodiments obtained by a person skilled in the art based on the embodiments of the present disclosure, without making any creative contribution, fall within the scope of protection of the present disclosure.

When a user displays his/her original content via an internet platform or shares the same with other users, background switching is often necessary in order to indicate a location change or enhance the mood. Therefore, in user generated content (UGC), the background switching has numerous application scenarios and usage requirements.

In the related art, when a UGC player needs to switch the background, the only way is to enclose a game scene with a skybox component, and to achieve the background switching through movement of the skybox component. This method presents significant implementation challenges and demands high-level game development expertise. Furthermore, due to game optimization constraints, the background cannot achieve high levels of detail and may severely limit the scale of a game level. Currently, the background switching provided by the official is only available under an editing mode of the game level. Since skybox resources are stored within the game scene, dynamically adjusting the skybox during a game requires a client to reload the entire scene, resulting in disruption to the user game experience.

In the related art, a plurality of skybox resources are provided. For these skybox resources, each map can only be utilized by a single player without dynamic skybox switching, which severely limits the UGC-creating limit. Furthermore, in the related art, the skybox relies solely on motion mechanism during the background switching, therefor the resulting background switching appears rather monotonous, failing to meet player expectations.

In view of the above problems, embodiments of the present disclosure provide a method and device for switching a sky background in a game and an electronic device, the technology of which is applicable to sky background switching of a game scene and switching-pausing scenarios in a game level.

In an embodiment of the present disclosure, the method for switching the sky background in the game may run on either a local terminal device or a server. When being applied to the server, the interaction control method in the game may be implemented and executed via a cloud interaction system including both the server and the client device.

In an implementation, the cloud interaction system may run various cloud applications, such as cloud gaming. For example, the cloud gaming refers to a gaming mode based on cloud computing. In the operating mode of the cloud gaming, the execution entity of the game program and the displaying entity of the game visual are different. The method for switching the sky background in the game is stored and run on the cloud gaming server. The client device receives and transmits data, and renders the game visual. For example, the client device may be a display device with data transmission capabilities located near a user, such as a mobile terminal, television, computer, or handheld computer. However, actual information processing occurs on the cloud-based game server. During gameplay, a player operates the client device to send operation commands to the cloud game server, the cloud game server runs the game based on these operation commands, encodes and compresses data such as game visuals, transmits the same over the network back to the client device, and then, the client device decodes and outputs the game visuals.

In an implementation, taking a game as an example, the local terminal device stores a game program thereof and is used to present game visuals. The local terminal device is used to interact with a player via a graphical user interface (GUI), typically involving conventional download, installation, and execution of the game program via an electronic device. The local terminal device may present the graphical user interface to the player in various manners, for example, the local termina device may render and display the graphical user interface on the display screen of the terminal device or may present the graphical user interface to the player via holographic projection. For example, the local terminal device may include a display screen and a processor. The display screen is used to present the graphical user interface including the game visuals. The processor is used to run the game, generate the graphical user interface, and control the graphical user interface to be displayed on the display screen.

In a possible implementation, an embodiment of the present disclosure provides a method for switching a sky background in a game, in which a graphical user interface is provided via a terminal device. The terminal device may the aforementioned local terminal device or a client device in the aforementioned cloud-based interaction system. The graphical user interface displays a portion of a game scene and a sky background corresponding to the game scene, and the sky background is a background generated based on sky background information. As illustrated in FIG. 1, the method includes the following specific steps.

In step S102, target sky background information and a switching parameter corresponding to a sky background switching event are determined in response to the sky background switching event.

The aforementioned sky background switching event denotes an event for starting to update the sky background information corresponding to the game scene, and may be determined based on a player setting or a development requirement. Similarly, the target sky background information and the switching parameter corresponding to the sky background switching event may also be determined based on a player setting or a player requirement. Specifically, a player may set, within a game editor, the sky background switching event, and the target sky background information and the switching parameter corresponding to the sky background switching event. The switching parameter includes at least one of a switching duration and a switching mode. The switching duration is used to indicate a time length required for updating the sky background information corresponding to the game scene from current sky background information to the target sky background information. The switching duration may be 0 seconds, 3 seconds, 5 seconds, or similar values.

In an embodiment, the aforementioned sky background switching event may be a triggering operation on a switching control displayed within the graphical user interface, may be that a controlled virtual object controlled by the terminal device enters a target area, or the like, which is not specifically limited herein.

In a specific implementation, when the player triggers the sky background switching event, the current sky background information of the game scene, and the target sky background information and switching parameter corresponding to the sky background switching event are obtained firstly. The current sky background information refers to sky background information corresponding to the game scene when the sky background switching event occurs. Specifically, the sky background information may be a sky background texture, a background parameter for controlling the sky background texture, or the like.

In an embodiment, the aforementioned game scene includes a skybox, the sky background information corresponding to the game scene is attribute information corresponding to the skybox, and the sky background is a background generated based on sky background information of the skybox. The skybox may encompass the entire game scene and provide the sky background for the game scene based on the sky background information. It should be noted that the sky background information corresponding to the skybox described below is the sky background information corresponding to the game scene.

In step S104, the sky background information corresponding to the game scene is updated from current sky background information to the target sky background information based on the switching parameter, and a dynamically-varying sky background of the game scene rendered during a process of updating the sky background information is dynamically displayed within the graphical user interface, wherein the process of updating the sky background information is a process of updating the sky background information corresponding to the game scene from the current sky background information to the target sky background information.

When the sky background switching event occurs, the sky background information corresponding to the game scene may be updated from the current sky background information to the target sky background information based on the switching parameter. During the process of updating the sky background information, the updated sky background information corresponding to the game scene is calculated in real-time for each updating, and the sky background of the game scene rendered based on the updated sky background information is displayed within the graphical user interface, so that an updated sky background is dynamically displayed within the graphical user interface, which allows a player to intuitively observe a varying sky background of the game scene that is varying by adjusting a game perspective.

In an embodiment, the process of updating the sky background information continues for a preset duration, or may complete instantly, which is determined by a player setting. Typically, the preset duration matches with the switching duration and may be determined according to player setting.

The embodiments of the present disclosure provide a method for switching a sky background in a game, in which a player may achieve switching of the sky background corresponding to the game scene during a gameplay by triggering the sky background switching event. Concurrently, in this method, the expression of sky background switching is enriched through the switching parameter, thereby enhancing the gaming experience of the player.

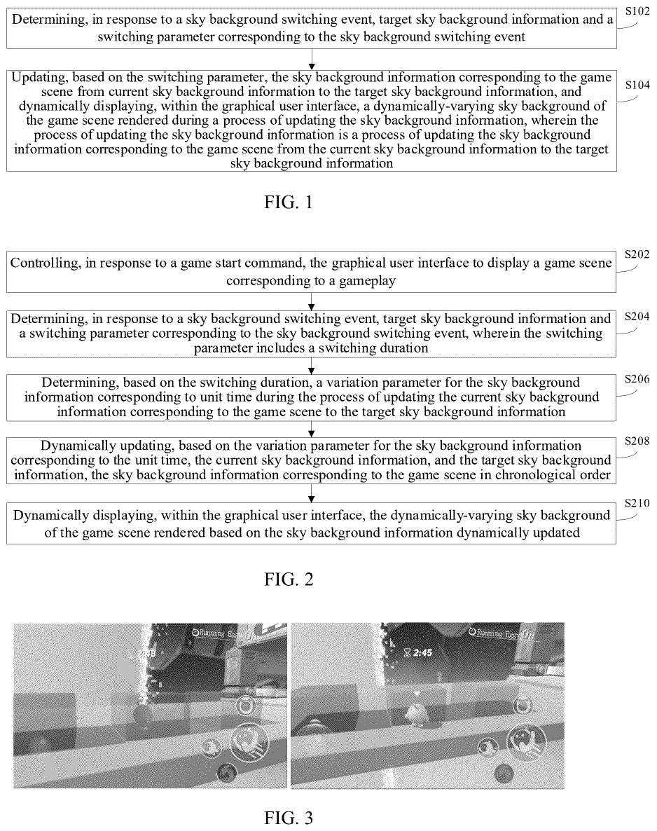

An embodiment of the present disclosure provides a method for switching a sky background in a game, which is implemented on the basis of the aforementioned embodiments. The method mainly describes the specific process of updating, based on the switching parameter which is the switching duration, the sky background information corresponding to the game scene from the current sky background information to the target sky background information, and dynamically displaying, within the graphical user interface, the dynamically-varying sky background of the game scene rendered during the process of updating the sky background information (achieved through the following steps S206-S210). As illustrated in FIG. 2, the method includes the following specific steps.

In step S202, the graphical user interface is controlled to display a game scene corresponding to a gameplay in response to a game start command.

The aforementioned game start command may be determined according to a game rule. For example, the game start command may be triggered by the player triggering a game start control within the graphical user interface, or may be triggered by the player triggering any region within the graphical user interface. When the graphical user interface displays the game scene corresponding to the gameplay, a controlled virtual object controlled by the terminal device is within the game level or gameplay.

In step S204, the target sky background information and the switching parameter corresponding to the sky background switching even are determined in response to the sky background switching event, wherein the switching parameter include the switching duration.

In step S206, a variation parameter for the sky background information corresponding to unit time during the process of updating the current sky background information corresponding to the game scene to the target sky background information is determined based on the switching duration.

In a specific implementation, the variation parameter is proportions of the target sky background information and the current sky background information in the updated sky background information. The aforementioned unit time is a time frame at which the sky background information corresponding to the game scene varies during the process of updating the current sky background information corresponding to the game scene to the target sky background information. For example, if the sky background information varies 10 times per second, each second includes 10 unit times. Consequently, the longer the switching duration, the greater the number of unit times at which the sky background information varies during the process of updating the current sky background information corresponding to the game scene to the target sky background information. Moreover, for the variation parameter corresponding to the unit time, the proportion of the target sky background information in the updated sky background information gradually increases over time, until it reaches 1. At this point, the updated sky background information is the target sky background information.

In step S208, the sky background information corresponding to the game scene is dynamically updated in chronological order based on the variation parameter for the sky background information corresponding to the unit time, the current sky background information, and the target sky background information.

In a specific implementation, the switching parameter may further include a switching mode, and for different switching modes, the manners of determining, based on the variation parameter for the sky background information corresponding to the unit time, the current sky background information, and the target sky background information, dynamically updated sky background information corresponding to the game scene are different.

In an embodiment, if the switching parameter further includes a first switching mode, and the sky background information includes a plurality of pixels, the aforementioned step S208 may be implemented via the following steps 10-12.

In step 10, a to-be-updated pixel among the plurality of pixels in the sky background information is dynamically determined in chronological order based on the first switching mode and the variation parameter, wherein the to-be-updated pixel is a part of the plurality of pixels in the sky background information.

Specifically, the aforementioned first switching mode typically involves gradually displaying the sky background rendered based on the target sky background information from one end to the other end of the sky background of the game scene. That is, the current sky background information corresponding to the game scene is replaced with the target sky background information in a progressive manner from one end to the other end. The first switching mode may be referred to as a progressive mode or a burning mode. If the switching parameter includes the first switching mode, it may dynamically determine, based on the variation parameter, which portion of pixels in the sky background information is the to-be-updated pixels.

Based on the foregoing description, the aforementioned variation parameter is proportions of pixels of the target sky background information and pixels of the current sky background information in pixels of the sky background information updated. In an embodiment, the variation parameter may further be proportions of a number of pixels in the current sky background information and a number of pixels in the target sky background information in the sky background information updated.

In step 11, a target pixel value corresponding to the to-be-updated pixel is determined based on the target sky background information.

In a specific implementation, if the target sky background information is a sky background texture, the pixel value corresponding to the to-be-updated pixel in the sky background texture may be determined as the target pixel value. If the target sky background information is a background parameter, the target pixel value of the to-be-updated pixel may be determined based on the background parameter.

In step 12, the pixel value of the to-be-updated pixel is updated from the current pixel value determined based on the current sky background information to the target pixel value.

FIG. 3 illustrates a schematic diagram of a sky background updated based on a first switching mode provided by an embodiment of the present disclosure. FIG. 3 illustrates a sky background rendered during a process of updating from a current sky background to a target sky background information. In the first image of FIG. 3, the portion at the right of the transition line at the countdown position represents the sky background of the game scene rendered based on the target sky background information, while the portion at the left of the transition line represents the sky background of the game scene rendered based on the current target sky background information. The countdown corresponding to the first image in FIG. 3 is 2 minutes 48 seconds, and the countdown corresponding to the second image in FIG. 3 is 2 minutes 45 seconds. It can be seen from FIG. 3 that the proportion of the sky background of the game scene rendered based on the target sky background information in the updated sky background gradually increases in chronological order.

In another embodiment, if the switching parameter further includes a second switching mode, and the sky background information includes a plurality of pixels, the aforementioned step S208 may be implemented via the following steps 20-22.

In step 20, a to-be-updated pixel among the plurality of pixels in the sky background information is determined based on the second switching mode, wherein the to-be-updated pixel is all pixels among the plurality of pixels in the sky background information.

Specifically, the aforementioned second switching mode refers to that for the sky background of the game scene, the entire sky background gradually emerges into the sky background rendered from the target sky background information from the sky background rendered based on the current sky background information. This mode may be referred to as a gradient mode or a transition mode. If the switching parameter includes the second switching mode, all pixels in the sky background information are determined to be to-be-updated pixels.

In step 21, a target pixel value corresponding to the to-be-updated pixel is determined based on the target sky background information, and a current pixel value corresponding to the to-be-updated pixel is determined based on the current sky background information.

In a specific implementation, if the target sky background information is a sky background texture, the pixel value corresponding to the to-be-updated pixel in the sky background texture may be determined as the target pixel value. If the target sky background information is a background parameter, the target pixel value for the to-be-updated pixel may be determined based on the background parameter. The aforementioned current pixel value refers to the pixel value corresponding to the to-be-updated pixel in the current sky background information.

In step 22, a pixel value of the to-be-updated pixel is dynamically updated based on the variation parameter, the target pixel value and the current pixel value in chronological order.

In a specific implementation, the variation parameter may be proportions of pixels of the target sky background information and pixels of the current sky background information in pixels of the sky background information updated. In an embodiment, the variation parameter may be proportions of a pixel value of each pixel in the current sky background information and a pixel value of each pixel in the target sky background information in the sky background information updated.

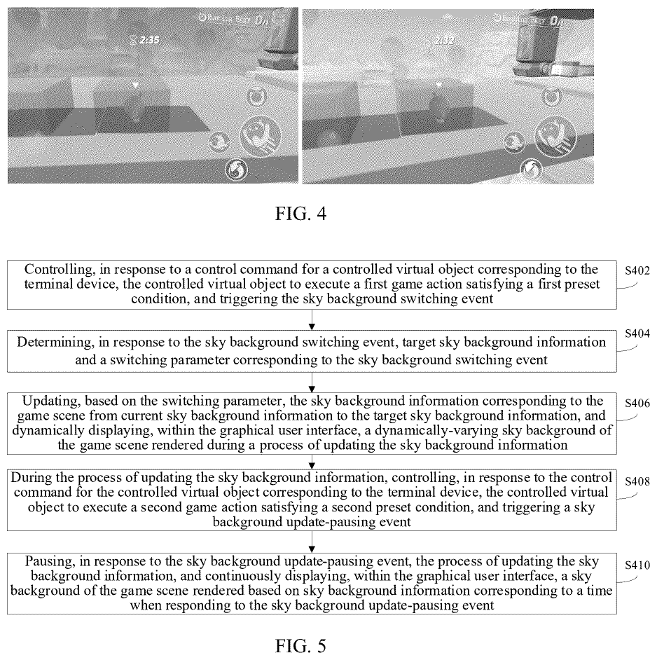

FIG. 4 illustrates a schematic diagram of a sky background updated based on a second switching mode provided by an embodiment of the present disclosure. FIG. 4 illustrates a sky background rendered during a process of updating from a current sky background to a target sky background information. The countdown corresponding to the first image in FIG. 4 is 2 minutes 35 seconds, and the countdown corresponding to the second image in FIG. 4 is 2 minutes 32 seconds. It can be seen from FIG. 4 that the sky background of the game scene rendered based on the target sky background information gradually emerges in the updated sky background in chronological order, that is, the proportion increases gradually.

In a specific embodiment, for each to-be-updated pixel, the current pixel value corresponding to the to-be-updated pixel and the target pixel value thereof may be added to obtain a sum, and then, the product of this sum and the variation parameter is determined as the pixel value of the to-be-updated pixel.

In step S210, the dynamically-varying sky background of the game scene rendered based on the dynamically updated sky background information is dynamically displayed within the graphical user interface.

In the above method for switching the sky background in the game, the sky background switching event may be triggered during the gameplay of the player, the sky background information corresponding to the game scene is dynamically updated to the target sky background information based on the switching mode and the switching duration corresponding to the sky background switching event, and a dynamically-varying sky background of the game scene rendered based on the dynamically updated sky background information is dynamically displayed within the graphical user interface, therefore the method enriches the expression of sky background switching, thereby enhancing the gaming experience of the player.

On the basis of the foregoing embodiments, the switching parameter described in the following embodiment includes a third switching mode. The third switching mode is a mode in which the sky background of the game scene is switched immediately.

Specifically, the target sky background information and the switching parameter corresponding to the sky background switching event are determined in response to the sky background switching event. The switching parameter includes a third switching mode. Based on the third switching mode, the sky background information corresponding to the game scene is switched from the current sky background information to the target sky background information, and a sky background of the game scene rendered based on the target sky background information is continuously displayed within the graphical user interface.

This method enables the immediate switching of the sky background information corresponding to the game scene to the target sky background information upon triggering the sky background switching event, so that the sky background in the graphical user interface changes instantly from the sky background rendered based on the current sky background information to the sky background rendered based on the target sky background information in a next frame, thereby achieving rapid sky background switching.

On the basis of the foregoing embodiments, the following embodiment describes a method for pausing the sky background switching.

Specifically, during the process of updating the sky background information, the process of updating the sky background information is paused in response to a sky background update-pausing event, and within the graphical user interface, a sky background of the game scene rendered based on sky background information corresponding to a time when responding to the sky background update-pausing event is continuously displayed.

During the process of updating the sky background information, if the sky background information corresponding to the game scene is not switched to the target sky background information, and the player triggers the sky background update-pausing event, the updating of the sky background information of the game scene is immediately stopped, and the sky background of the game scene rendered based on the sky background information corresponding to the time when responding to the sky background update-pausing event is continuously displayed within the graphical user interface. At this point, the sky background of the game scene displayed within the graphical user interface may include a sky background formed by a first portion of a sky background of the game scene rendered based on the current sky background information and a second portion of a sky background of the game scene rendered based on the target sky background information, and the first and second portions may constitute a complete sky background.

In some embodiments, a preset transition effect corresponding to a junction portion between the first portion of the sky background of the game scene rendered based on the current sky background information and the second portion of the sky background of the game scene rendered based on the target sky background information is displayed within the sky background corresponding to the game scene. The preset transition effect is a transition effect corresponding to the first switching mode, which includes a transition color and a transition style that may be determined as required within the game editor.

In a specific implementation, the aforementioned sky background update-pausing event may be determined based on a player setting or a development requirement. Specifically, the player may set the sky background update-pausing event within the game editor. The sky background update-pausing event serves as a trigger event to indicate the pausing of updating the sky background information corresponding to the game scene. In an embodiment, the graphical user interface further displays a switching control and a pause control, the sky background switching event includes triggering of the switching control, and the sky background update-pausing event includes triggering of the pause control.

Based on the foregoing description, an embodiment of the present disclosure further provides another method for switching a sky background in a game, and as illustrated in FIG. 5, the method includes the following specific steps.

In step S402, in response to a control command for a controlled virtual object corresponding to the terminal device, the controlled virtual object is controlled to execute a first game action satisfying a first preset condition, and the sky background switching event is triggered.

In a specific implementation, the first game action corresponding to the first preset condition may be determined based on a player setting. Optionally, the first game action corresponding to the first preset condition may be to control the controlled virtual object to move to a target area within the game scene. The target area is a specific scene area within the game scene, and the location of the scene area within the game scene may be determined based on a player setting.

In step S404, the target sky background information and the switching parameter corresponding to the sky background switching event are determined in response to the sky background switching event.

In step S406, the sky background information corresponding to the game scene is updated from the current sky background information to the target sky background information based on the switching parameter, and the dynamically-varying sky background of the game scene rendered during the process of updating the sky background information is dynamically displayed within the graphical user interface.

In step S408, during the process of updating the sky background information, the controlled virtual object is controlled to execute a second game action satisfying a second preset condition in response to the control command for the controlled virtual object corresponding to the terminal device, and the sky background update-pausing event is triggered.

In step S410, the process of updating the sky background information is paused in response to the sky background update-pausing event, and the sky background of the game scene rendered based on the sky background information corresponding to the time when responding to the sky background update-pausing event is continuously displayed within the graphical user interface.

In a specific implementation, the second game action corresponding to the second preset condition may be determined based on a player setting. Optionally, the second game action corresponding to the second preset condition may be to control the controlled virtual object to separate from the target area within the game scene.

In the above method, the player may control the sky background to be switched and paused by controlling the movement of the controlled virtual object, thereby enriching gameplay.

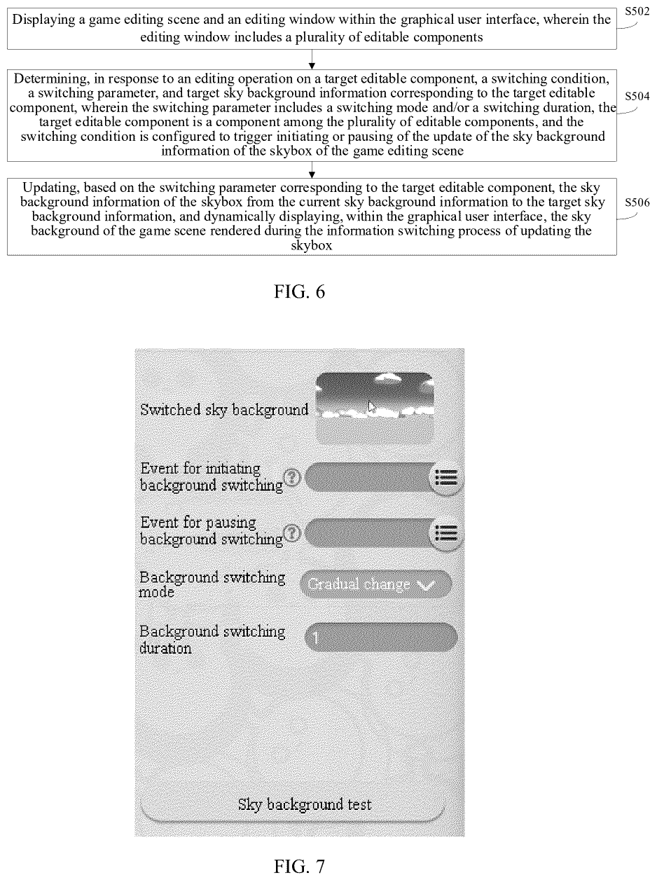

An embodiment of the present disclosure further provides another method for switching a sky background in a game, which mainly describes the setting manner of the sky background switching event, the sky background update-pausing event, the target sky background information, and the switching parameter. As illustrated in FIG. 6, the method includes the following specific steps.

In step S502, a game editing scene and an editing window are displayed within the graphical user interface, wherein the editing window includes a plurality of editable components.

The aforementioned game editing scene is a scene provided when running a game program and may also be understood as a scene provided by the game editor. The editable component may be edited within the game editing scene. In a specific implementation, when a player triggers a game editing command, the game editing scene and the editing window may be displayed within the graphical user interface. This game editing command may be determined according to a game rule. For example, the editing command may be an operation of entering the game editor, or selecting a specific scene map for editing.

The aforementioned editing window may include a plurality of editable components with a specific component type and form that may be set according to a development requirement. In a practical application, the editing window may include various types of editable components, such as terrain component, mechanism component, decorative component, and combination component. Moreover, each type of editable component may include a plurality of editable components. The display parameters of the editable components of the same type may be different in a gameplay scene, that is, some editable components are visible both in the game editing scene and the gameplay scene, while some editable components are visible in the game editing scene and invisible in the gameplay scene. For example, terrain components such as the large baseplate component and fan-shaped platform component, along with mechanism components such as the cylinder component and gear component, are all editable components visible in both the game editing scene and the gameplay scene. However, the spawn point component and the respawn point component corresponding to the logic-based component in mechanism components are visible in the game editing scene but invisible in the gameplay scene.

In a specific embodiment, after the editing window is displayed within the graphical user interface, a virtual object corresponding to the target editable component is generated within the game editing scene in response to a selection operation of a target editable component, wherein the virtual object is configured to be displayed using a preset display parameter. The aforementioned preset display parameter is visible or invisible in the gameplay scene. In a specific implementation, the detail of the aforementioned selection operation may be determined according to a development requirement. For example, this selection operation may be to drag the target editable component into the game editing scene, or click or long-press the target editing component within the editing window.

In step S504, a switching condition, a switching parameter, and target sky background information corresponding to the target editable component are determined in response to an editing operation on the target editable component, wherein the switching parameter includes a switching mode and/or a switching duration, the target editable component is a component among the plurality of editable components, and the switching condition is configured to trigger initiating or pausing of the update of the sky background information of the skybox of the game editing scene.

In a practical application, the aforementioned switching parameter may include solely the switching mode, solely the switching duration, or both thereof. The switching condition corresponds to the sky background switching event and the sky background update-pausing event in the aforementioned embodiments. The detail of the editing operation may be determined based on a development requirement and a player setting.

In step S506, the sky background information of the skybox is updated from the current sky background information to the target sky background information based on the switching parameter corresponding to the target editable component, and the sky background of the game scene rendered during the information switching process of updating the skybox is dynamically displayed within the graphical user interface.

After the switching condition, the switching parameter, and the target sky background information corresponding to the target editable component are set, by triggering an interaction control within the graphical user interface, the sky background information of the skybox is updated from the current sky background information to the target sky background information based on the switching parameter corresponding to the target editable component, and the sky background of the game scene rendered during the information switching process of updating the skybox is dynamically displayed within the graphical user interface. Herein, the sky background information of the skybox may also be understood as the sky background information of the game scene.

In this method, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, the aforementioned graphical user interface displays a setting control, and the step S506 may be implemented through the following steps 30-33.

In step 30, a parameter setting panel corresponding to the target editable component is displayed within the editing window in response to a trigger operation on the setting control, wherein the parameter setting panel includes a plurality of editable controls, and the editable controls are configured to set the switching condition, the switching parameter, and the target sky background information of the target editable component.

In a specific implementation, the aforementioned trigger operation on the setting control may be clicking or long-pressing operation on the setting control for triggering the setting control, so that the parameter setting panel corresponding to the target editable component may be displayed. The parameter setting panel is used to set the sky background switching event, the sky background update-pausing event, the target sky background information, and the background switching parameter corresponding to the target editable component.

In step 31, the switching condition corresponding to the target editable component is determined in response to a first setting operation on the parameter setting panel.

In a specific implementation, the detail of the aforementioned first setting operation may be determined based on a player operation. The switching condition includes a sky background switching event for the target editable component initiating background switching, and a sky background update-pausing event for the target editable component pausing the background switching. The parameter setting panel includes a first editable control configured to set the sky background switching event, and a second editable control configured to set the sky background update-pausing event. Therefore, the sky background switching event corresponding to the target editable component may be set in response to and based on a first input operation on the first editable control, and the sky background update-pausing event corresponding to the target editable component may be set in response to and based on a second input operation on the second editable control.

The aforementioned first and second input operations may be determined based on a player operation, and the player may perform the input operation on the full keyboard. In an embodiment, the aforementioned first input operation includes setting a target component associated with the target editable component, and setting the sky background switching event as the movement of the controlled virtual object controlled by the terminal device to a scene space determined by the target component, and the second input operation sets the sky background update-pausing event as the movement of the controlled virtual object out of the scene space determined by the target component. The scene space is a specific area within the game scene.

In another embodiment, the first input operation includes setting a switching control within the graphical user interface, and setting the sky background switching event as triggering of the switching control, and the second input operation include setting a pause control within the graphical user interface, and setting the sky background update-pausing event as triggering of the pause control.

In step 32, the switching parameter corresponding to the target editable component is determined in response to a second setting operation on the parameter setting panel.

In a specific implementation, the detail of the aforementioned second setting operation may be determined based on a player operation. The aforementioned switching parameter includes a switching mode. Accordingly, the method for setting the switching parameter includes: in response to a clicking operation on the editable control corresponding to the switching mode within the parameter setting panel, displaying a plurality of preset switching modes within the parameter setting panel, wherein different switching modes correspond to different methods for determining the to-be-updated pixel of the sky background information of the skybox, and the sky background information includes a plurality of pixels; and in response to a trigger operation on a target switching mode of the plurality of preset switching modes, determining the target switching mode as the switching mode corresponding to the target editable component. The plurality of preset switching modes may include a first switching mode, a second switching mode, and a third switching mode.

In a specific implementation, if the target switching mode includes the first switching mode, the method further includes: in response to a trigger operation on a target switching mode of the plurality of preset switching modes, displaying a transition setting control corresponding to the target switching mode in the parameter setting panel, wherein the transition setting control is used to set a transition effect for the junction portion between the to-be-updated pixels and the pixels not updated in the sky background information of the skybox; and in response to a setting operation on the transition setting control, determining the transition effect corresponding to the target switching mode, and determining both the target switching mode and its corresponding transition effect as the switching mode corresponding to the target editable component. The transition effect may include a transition color and/or a transition style.

In an embodiment, the switching parameter includes a switching duration. Accordingly, the method for determining the switching parameter corresponding to the target editable component includes: in response to an input operation for the switching duration within the parameter setting panel, determining an input value corresponding to the input operation as the switching duration corresponding to the target editable component, wherein the switching duration represents the time for updating the sky background information of the skybox from the current sky background information to the target sky background information. Specifically, the input value corresponding to the aforementioned input operation may be determined based on a player operation. For example, this input value may be 5 seconds or 10 seconds.

In step 33, the target sky background information corresponding to the target editable component is determined in response to a third setting operation on the parameter setting panel.

In a specific implementation, the detail of the aforementioned third setting operation may be determined based on a player operation.

In an embodiment, the target sky background information corresponding to the target editable component may be determined via the following steps 40-42.

In step 40, a custom background option and at least one preset sky background texture are displayed within the parameter setting panel in response to a trigger operation on the editable control corresponding to the target sky background information within the parameter setting panel.

In a specific implementation, the custom background option may be configured for the player to set the target sky background information corresponding to the target editable component according to his/her requirement, and the preset sky background texture is a system-provided background texture with a specified style.

In step 41, the target sky background information is determined based on a first sky background texture in response to a trigger operation on the first sky background texture of the at least one preset sky background texture.

The aforementioned first sky background texture may be any of the preset sky background textures, and a specific preset sky background texture may be determined as the first sky texture based on a player operation. In a specific implementation, the first sky background texture may be determined as the target sky background information.

In an embodiment, a texture setting control may also be displayed within the parameter setting panel in response to a trigger operation on the first sky background texture among the at least one preset sky background texture. The texture setting control is configured to set a texture parameter of the first sky background texture, and the texture parameter includes at least one of a texture color, a texture saturation, or a texture transparency. The texture parameter of the first sky background texture is adjusted in response to a setting operation on the texture setting control to obtain an adjusted first sky background texture, and the adjusted first sky background texture is determined as the target sky background information. In this method, the player may adjust the selected sky background texture according to his/her requirement, and thus may rapidly determine the target sky background information.

In an embodiment, a custom setting control may be further displayed within the parameter setting panel in response to a trigger operation on the custom background option. A plurality of preset background parameters may be displayed within the parameter setting panel in response to a trigger operation on the custom setting control. A plurality of target background parameters are obtained in response to a setting operation on the plurality of preset background parameters, and the plurality of target background parameters are determined as the target sky background information. Specifically, the aforementioned preset background parameters include at least one of a first gradient color, a second gradient color, a gradient axis direction, an axis center position, or a gradient contrast. When the target sky background information is a plurality of target background parameters, the sky background including at least two gradient colors may be rendered based on the plurality of target background parameters.

In an embodiment, a no-transition background option is displayed within the parameter setting panel in response to a trigger operation on an editable control corresponding to the target sky background information within the parameter setting panel. The no-transition background option is configured to indicate that the target editable component is disabled. Pop-up information is displayed within the graphical user interface in response to a trigger operation on the no-transition background option. The pop-up information is configured to indicate that applying the no-transition background option may disable the target editable component. The target editable component is disabled in response to a confirmation operation on the pop-up information. In a specific implementation, if the no-transition background option is triggered, the target editable component may not switch the sky background, i.e., the target editable component is disabled. The aforementioned pop-up information may include a prompt for the player to again confirm to select the no-transition background option, and a warning of a resulting effect of such selection.

In a specific implementation, after the target editable component is disabled, prompt information is displayed within the graphical user interface in response to a trigger operation on the target editable component. This prompt information may be configured to indicate disablement reason of the target editable component and method for removing the disablement. Specifically, the disablement reason may be selection of the no-transition background option, and the method for removing the disablement may be to switch to a transition background and then to enable the target editable component.

In an embodiment, the parameter setting panel further includes a first interaction control. The first interaction control is configured to preview the sky background transition effect corresponding to the target editable component in the game editing scene. Specifically, the switching parameter set based on the target editable component is displayed within the graphical user interface in response to a trigger operation on the first interaction control, and during the process of updating the sky background information of the skybox (equivalent to the sky background information corresponding to the game scene) from the current sky background information to the target sky background information set by the target editable component, the sky background of the game scene is obtained by rendering the sky background information of the skybox. In this method, the player may examine whether the sky background transition effect meets his/her requirement with the preview function provided by the first interaction control.

To facilitate understanding of the implementation of the present disclosure, FIG. 7 illustrates a schematic diagram of a parameter setting panel provided by an embodiment of the present disclosure. In FIG. 7, the control corresponding to the switched sky background is the editable control corresponding to the target sky background information. The “event for initiating background switching” in FIG. 7 refers to the sky background switching event, with its corresponding editable control being the first editable control, and when a player clicks this first editable control, the full keyboard may pop up. The “event for pausing background switching” corresponds to the sky background update-pausing event, with its corresponding editable control being the second editable control, and when a player clicks this second editable control, the full keyboard may pop up. The player may then input corresponding events within the pop-up keyboard to serve as the sky background switching event and the sky background update-pausing event. When the player clicks the editable control corresponding to the background switching mode in FIG. 7, a dropdown list including a plurality of preset switching modes may be displayed. In FIG. 7, the player has selected the gradient (gradual change) switching mode. The editable control corresponding to the background switching duration in FIG. 7 may display a numeric keypad, and by clicking a number on the keypad, the player may set the background switching duration. In FIG. 7, the background switching duration is set to 5 seconds. The sky background test control in FIG. 7 is the first interaction control.

In an embodiment, the graphical user interface further displays a second interaction control. The second interaction control simulates a gameplay scene, and the game may be trialed within the simulated gameplay scene. Accordingly, the aforementioned method for switching the sky background in the game may further be implemented through the following steps 50-55.

In step 50, in response to a trigger operation on a second interaction control, a game scene corresponding to the game editing scene is generated based on the editable component within the game editing scene. The game scene includes a controlled virtual object corresponding to the terminal device and a virtual object generated based on the editable component and displayed with a preset display parameter. The preset display parameter includes visible and invisible states.

In step 51, in response to a movement command for the controlled virtual object, the controlled virtual object is controlled to move to a scene space corresponding to the target component, thereby determining that the sky background switching event is satisfied.

In step 52, in response to the sky background switching event, the target sky background information and the switching parameter corresponding to the sky background switching event are determined.

In step 53, the sky background information corresponding to the game scene is updated from current sky background information to the target sky background information based on the switching parameter, and a dynamically-varying sky background of the game scene rendered during a process of updating the sky background information is dynamically displayed within the graphical user interface, wherein the process of updating the sky background information is a process of updating the sky background information corresponding to the game scene from the current sky background information to the target sky background information.

In step 54, during the process of updating the sky background information, in response to a movement command for the controlled virtual object, the controlled virtual object is controlled to separate from the scene space corresponding to the target component, thereby determining that the sky background update-pausing event is satisfied.

In step 55, in response to the sky background update-pausing event, the process of updating the sky background information is paused, and a sky background of the game scene rendered based on sky background information corresponding to a time when responding to the sky background update-pausing event is continuously displayed within the graphical user interface.

In the aforementioned method, the player may trial the game within the generated game scene corresponding to the game editing scene. Simultaneously, when the game is trialed, the sky background of the game scene rendered during the updating process from the current sky background information to the target sky background information may be displayed by triggering the sky background switching event, so that the player may further determine whether the set sky background switching effect meets his/her requirement.

In an embodiment, the aforementioned graphical user interface further displays a third interaction control. In response to a touch operation on the third interaction control, game scene information corresponding to the game editing scene is generated. The game scene information includes component information of edited components within the game editing scene, and the edited components are those responding to editing operations among a plurality of editable components within the editing window. The game scene information is transmitted to a server. The server is configured to communicate with a first terminal device configured with a game program. A second terminal device is configured to obtain the game scene information from the server and generate a corresponding game scene via the game program based on the game scene information. The first terminal device may be a device on which the third interaction control is touched or any other terminal device connected to the server.

After the third interaction control is triggered via a terminal device, the game scene information corresponding to the game editing scene may be generated. This game scene information may be stored in a preset location, which may be within a map file. This map file stores not only the game scene information but also other map information (including but not limited to screenshots, map names, logs, etc.). After storing the game scene information, the map file is uploaded to the server. Upon the approval, the server may publish the game scene generated based on the game scene information in a predefined map pool, then the terminal device connected to the server may download the corresponding game scene information from the server, and generates a corresponding game scene based on the game scene information through the game program, so that the player may trial the game in the game scene. This method may publish the game scene information in the game editor for other players to experience, thereby achieving rapid UGC function.

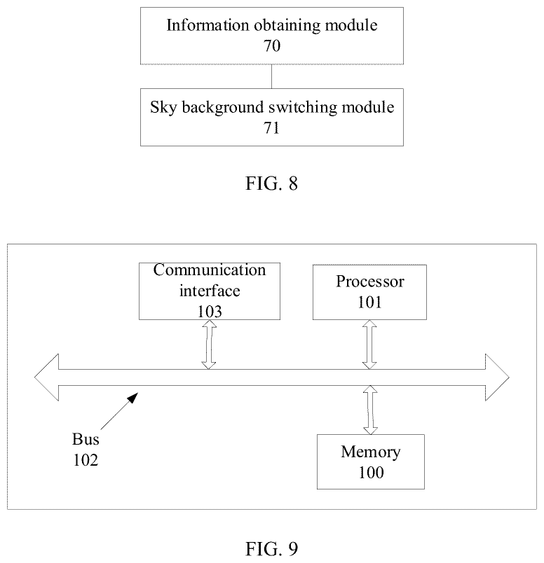

In relation to the aforementioned method embodiments, an embodiment of the present disclosure further provides a device for switching a sky background in a game, in which a graphical user interface is provided via a terminal device and displays a scene view of a portion of a game scene and a sky background corresponding to the game scene, and the sky background is a background generated based on sky background information. As illustrated in FIG. 8, the device includes:
an information obtaining module 70, configured to determine, in response to a sky background switching event, target sky background information and a switching parameter corresponding to the sky background switching event; and
a sky background switching module 71, configured to update, based on the switching parameter, sky background information corresponding to the game scene from current sky background information to the target sky background information, and dynamically display, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

In the above device for switching the sky background in the game, a player may achieve switching of the sky background corresponding to the game scene during a gameplay by triggering the sky background switching event. Concurrently, in this manner, the expression of sky background switching is enriched through the switching parameter, thereby enhancing the gaming experience of the player.

Further, the process of updating the sky background information continues for a preset duration.

The process of updating the sky background information continues for the preset duration, so that the process of updating the sky background may be dynamically displayed within the graphical user interface, which allows a player to intuitively observe a varying sky background of the game scene that is varying by adjusting a game perspective.

The aforementioned device further includes a game start module configured to, prior to determining, in response to the sky background switching event, the target sky background information and the switching parameter corresponding to the sky background switching event: control, in response to a game start command, the graphical user interface to display a game scene corresponding to a gameplay.

By triggering the game start command to display the game scene corresponding to the gameplay within the graphical user interface, the game perspective may be focused on the current gameplay as a controlled virtual object is within a game level or gameplay, which facilitates subsequent operations of the player.

In a specific implementation, the aforementioned game scene includes a skybox, the sky background information is attribute information corresponding to the skybox, and the sky background is a background generated based on sky background information of the skybox.

The skybox may encompass the entire game scene and provide the sky background for the game scene based on the sky background information, which facilitates subsequent rapid updating of the entire sky background information corresponding to the game scene from the current sky background information to the target sky background information.

Furthermore, the aforementioned device also includes a switching pause module, which is configured to: during the process of updating the sky background information, pause, in response to a sky background update-pausing event, the process of updating the sky background information, and continuously display, within the graphical user interface, a sky background of the game scene rendered based on sky background information corresponding to a time when responding to the sky background update-pausing event.

During the process of updating the sky background information, a user may trigger the sky background update-pausing event in real-time to display the sky background of the game scene rendered based on the sky background information corresponding to the time of the occurrence of the update-pausing event, which facilitates the player to flexibly control the entire sky background updating process within the game scene.

In a practical application, the aforementioned sky background of the game scene rendered based on the sky background information corresponding to the time when responding to the sky background update-pausing event includes a sky background formed by a first portion of a sky background of the game scene rendered based on the current sky background information and a second portion of a sky background of the game scene rendered based on the target sky background information.

As the sky background update-pausing event occurs at any point during the process of updating the sky background information corresponding to the game scene from the current sky background information to the target sky background information, the sky background is typically formed of the first portion of the sky background of the game scene rendered based on the current sky background information and the second portion of the sky background of the game scene rendered based on the target sky background information, which facilitates the player to flexibly control the entire sky background updating process within the game scene. Specifically, the timing at which the player triggers the sky background update-pausing event allows flexible determination of the proportions of the first portion and the second portion in the entire sky scene of the game scene.

In an embodiment, a preset transition effect corresponding to a junction portion between the first portion of the sky background of the game scene rendered based on the current sky background information and the second portion of the sky background of the game scene rendered based on the target sky background information is displayed within the sky background corresponding to the game scene

The updating of the sky background is implemented to have the preset transition effect, which shows the dynamic transition effect of the sky background update to the player, thereby making the sky background updating process more natural.

In an embodiment, the aforementioned device further includes a first event trigger module configured to, prior to responding to the sky background switching event: control, in response to a control command for a controlled virtual object corresponding to the terminal device, the controlled virtual object to execute a first game action satisfying a first preset condition; and trigger the sky background switching event. The aforementioned device further includes a second event trigger module configured to, prior to responding to the sky background update-pausing event: control, in response to the control command for the controlled virtual object corresponding to the terminal device, the controlled virtual object to execute a second game action satisfying a second preset condition; and trigger the sky background update-pausing event.

In the aforementioned manner, the player may control the switching of the sky background and the pausing of the switching by controlling the movement of the controlled virtual object, thereby enriching gameplay.

Furthermore, the first game action corresponding to the first preset condition is to control the controlled virtual object to move to a target area within the game scene, and the second game action corresponding to the second preset condition is to control the controlled virtual object to separate from the target area within the game scene.

In the above manner, the player may achieve the switching of the sky background and the pausing of the switching by controlling the controlled virtual object to move to the target area and controlling the controlled virtual object to separate from the target area within the game scene, thereby enriching gameplay.

In an embodiment, the aforementioned graphical user interface further displays a switching control and a pause control, the sky background switching event includes triggering of the switching control, and the sky background update-pausing event includes triggering of the pause control.

In this manner, the player may trigger the sky background switching event and the sky background update-pausing event respectively via the switching control and the pause control displayed within the graphical user interface, which facilitates the player operation and enriches gameplay.

In a specific implementation, the aforementioned switching parameter includes a switching duration, and the aforementioned sky background switching module 71 is configured to: determine, based on the switching duration, a variation parameter for the sky background information corresponding to unit time during the process of updating the current sky background information corresponding to the game scene to the target sky background information; dynamically update, based on the variation parameter for the sky background information corresponding to the unit time, the current sky background information, and the target sky background information, the sky background information corresponding to the game scene in chronological order; and dynamically display, within the graphical user interface, the dynamically-varying sky background of the game scene rendered based on the sky background information dynamically updated.

In the aforementioned manner for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background information is dynamically displayed within the graphical user interface. Concurrently, in this manner, the expression of sky background switching is enriched, thereby enhancing the gaming experience of the player.

Furthermore, the aforementioned switching parameter further includes a first switching mode, the sky background information includes a plurality of pixels, and the aforementioned sky background switching module 71 is also configured to: dynamically determine, based on the first switching mode and the variation parameter, a to-be-updated pixel among the plurality of pixels in the sky background information in chronological order, wherein the to-be-updated pixel is a part of the plurality of pixels in the sky background information; determine a target pixel value corresponding to the to-be-updated pixel based on the target sky background information; and update the pixel value of the to-be-updated pixel from a current pixel value determined based on the current sky background information to the target pixel value.

Furthermore, the aforementioned switching parameter further includes a second switching mode, the sky background information includes a plurality of pixels, and the aforementioned sky background switching module 71 is also configured to dynamically update, based on the variation parameter for the sky background information corresponding to the unit time, the current sky background information, and the target sky background information, the sky background information corresponding to the game scene in the chronological order, including: determining, based on the second switching mode, a to-be-updated pixel among the plurality of pixels in the sky background information, wherein the to-be-updated pixel is all pixels among the plurality of pixels in the sky background information; determining a target pixel value corresponding to the to-be-updated pixel based on the target sky background information, and determining a current pixel value corresponding to the to-be-updated pixel based on the current sky background information; and dynamically updating, based on the variation parameter, the target pixel value and the current pixel value, a pixel value of the to-be-updated pixel in chronological order.

In a specific implementation, the aforementioned variation parameter is proportions of the target sky background information and the current sky background information in the sky background information updated. Further, that the variation parameter is the proportions of the target sky background information and the current sky background information in the sky background information updated is that the variation parameter is proportions of pixels of the target sky background information and pixels of the current sky background information in pixels of the sky background information updated.

In a practical application, that the variation parameter is the proportions of the pixels of the target sky background information and the pixels of the current sky background information in the pixels of the sky background information updated includes at least one of: proportions of a pixel value of each pixel in the current sky background information and a pixel value of each pixel in the target sky background information in the sky background information updated; or proportions of a number of pixels in the current sky background information and a number of pixels in the target sky background information in the sky background information updated.

In the aforementioned manner for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background information is dynamically displayed within the graphical user interface. Concurrently, in this manner, the expression of sky background switching is enriched, thereby enhancing the gaming experience of the player.

In an embodiment, the aforementioned switching parameter includes a third switching mode, and the aforementioned device further includes a sky switching module configured to: switch, based on the third switching mode, the sky background information corresponding to the game scene from the current sky background information to the target sky background information, and continuously display, within the graphical user interface, a sky background of the game scene rendered based on the target sky background information.

This manner enables the immediate switching of the sky background information corresponding to the game scene to the target sky background information upon triggering the sky background switching event, so that the sky background in the graphical user interface changes instantly from the sky background rendered based on the current sky background information to the sky background rendered based on the target sky background information in a next frame, thereby achieving rapid sky background switching.

Furthermore, the aforementioned device further includes an information setting module, including: a window display unit for displaying a game editing scene and an editing window within the graphical user interface, wherein the editing window includes a plurality of editable components; a component selection unit for generating, in response to a selection operation of a target editable component, a virtual object corresponding to the target editable component within the game editing scene, wherein the virtual object is configured to be displayed using a preset display parameter, and the target editable component is a component of the plurality of editable components; and a component editing unit for determining, in response to an editing operation on the target editable component, a switching condition, a switching parameter, and target sky background information corresponding to the target editable component, wherein the switching condition includes a sky background switching event for the target editable component initiating background switching, and a sky background update-pausing event for the target editable component pausing the background switching.

In this manner, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In a specific implementation, a setting control is displayed within the graphical user interface, and the aforementioned component editing unit is configured to: display, in response to a trigger operation on the setting control, a parameter setting panel corresponding to the target editable component within the editing window, wherein the parameter setting panel includes a plurality of editable controls, and the editable controls are configured to set the switching condition, the switching parameter, and the target sky background information of the target editable component; determine, in response to a first setting operation on the parameter setting panel, the switching condition corresponding to the target editable component; determine, in response to a second setting parameter on the parameter setting panel, the switching parameter corresponding to the target editable component; and determine, in response to a third setting operation on the parameter setting panel, the target sky background information corresponding to the target editable component.

In this manner, the player may freely set the sky background switching event, the sky switching parameter, and the target sky background information corresponding to the target editable component in the game editing scene. This enriches the expression of sky background switching, thereby enhancing the gaming experience of the player.

Furthermore, the aforementioned parameter setting panel includes a first editable control configured to set the sky background switching event, and a second editable control configured to set the sky background update-pausing event. The aforementioned component editing unit is configured to: set, in response to and based on a first input operation on the first editable control, the sky background switching event corresponding to the target editable component; and set, in response to and based on a second input operation on the second editable control, the sky background update-pausing event corresponding to the target editable component

In a specific implementation, the aforementioned component editing unit is further configured to: display, in response to a trigger operation on the editable control corresponding to the target sky background information within the parameter setting panel, a custom background option and at least one preset sky background texture within the parameter setting panel; and determine, in response to a trigger operation on a first sky background texture of the at least one preset sky background texture, the target sky background information based on the first sky background texture.

In this manner, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, the aforementioned component editing unit is further configured to: display, in response to a trigger operation on the custom background option, a custom setting control within the parameter setting panel; display, in response to a trigger operation on the custom setting control, a plurality of preset background parameters within the parameter setting panel; and obtain, in response to a setting operation on the plurality of preset background parameters, a plurality of target background parameters, and determine the plurality of target background parameters as the target sky background information.

In a specific implementation, the aforementioned preset background parameters include at least one of a first gradient color, a second gradient color, a gradient axis direction, an axis center position, or a gradient contrast.

The custom background option enables the player to personalize the target background parameter, thereby enhancing sense of participation in the game and experience feeling of the player, and improving the flexibility of the sky background within the game scene. Simultaneously, determining the target sky background information based on the plurality of preset background parameters may improve the intuitiveness of parameter setting.

In an embodiment, the aforementioned parameter setting panel further includes a first interaction control. The aforementioned device includes a display switching module configured to: display, in response to a trigger operation on the first interaction control, the switching parameter set based on the target editable component within the graphical user interface, and during the process of updating the sky background information corresponding to the game scene from the current sky background information to the target sky background information, render the sky background of the game scene.

In this manner, the player utilizes the preview function provided by the first interaction control to examine whether the sky background switching effect meets his/her requirement.

The device for switching the sky background in the game provided in the embodiments of the present disclosure shares the same implementation principles and technical effects as the aforementioned method embodiments. For the sake of brevity, the aspects not mentioned in the device embodiments may refer to the corresponding content of the above method embodiments.

An embodiment of the present disclosure further provides an electronic device. As illustrated in FIG. 9, the electronic device includes a processor and a memory. The memory stores machine-executable instructions that can be executed by the processor. The processor executes the machine-executable instructions to implement the aforementioned method for switching the sky background in the game.

Specifically, a graphical user interface is provided via a terminal device and displays a portion of a game scene and a sky background corresponding to the game scene, and the sky background is a background generated based on sky background information. The method for switching the sky background in the game includes: determining, in response to a sky background switching event, target sky background information and a switching parameter corresponding to the sky background switching event; and updating, based on the switching parameter, the sky background information corresponding to the game scene from current sky background information to the target sky background information, and dynamically displaying, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

In the method for switching the sky background in the game, a player may achieve switching of the sky background corresponding to the game scene during a gameplay by triggering the sky background switching event. Concurrently, in this method, the expression of sky background switching is enriched through the switching parameter, thereby enhancing the gaming experience of the player.

In an embodiment, the process of updating the sky background information continues for a preset duration.

The process of updating the sky background information continues for the preset duration, so that the process of updating the sky background may be dynamically displayed within the graphical user interface, which allows a player to intuitively observe a varying sky background of the game scene that is varying by adjusting a game perspective.

In an embodiment, the method further includes, prior to determining, in response to the sky background switching event, the target sky background information and the switching parameter corresponding to the sky background switching event: controlling, in response to a game start command, the graphical user interface to display a game scene corresponding to a gameplay.

By triggering the game start command to display the game scene corresponding to the gameplay within the graphical user interface, the game perspective may be focused on the current gameplay as a controlled virtual object is within a game level or gameplay, which facilitates subsequent operations of the player.

In an embodiment, the aforementioned game scene includes a skybox, the sky background information is attribute information corresponding to the skybox, and the sky background is a background generated based on sky background information of the skybox.

The skybox may encompass the entire game scene and provide the sky background for the game scene based on the sky background information, which facilitates subsequent rapid updating of the entire sky background information corresponding to the game scene from the current sky background information to the target sky background information.

In an embodiment, the aforementioned method further includes: during the process of updating the sky background information, pausing, in response to a sky background update-pausing event, the process of updating the sky background information, and continuously displaying, within the graphical user interface, a sky background of the game scene rendered based on sky background information corresponding to a time when responding to the sky background update-pausing event.

During the process of updating the sky background information, a user may trigger the sky background update-pausing event in real-time to display the sky background of the game scene rendered based on the sky background information corresponding to the time of the occurrence of the update-pausing event, which facilitates the player to flexibly control the entire sky background updating process within the game scene.

In an embodiment, the aforementioned sky background of the game scene rendered based on the sky background information corresponding to the time when responding to the sky background update-pausing event includes a sky background formed by a first portion of a sky background of the game scene rendered based on the current sky background information and a second portion of a sky background of the game scene rendered based on the target sky background information.

As the sky background update-pausing event occurs at any point during the process of updating the sky background information corresponding to the game scene from the current sky background information to the target sky background information, the sky background is typically formed of the first portion of the sky background of the game scene rendered based on the current sky background information and the second portion of the sky background of the game scene rendered based on the target sky background information, which facilitates the player to flexibly control the entire sky background updating process within the game scene. Specifically, the timing at which the player triggers the sky background update-pausing event allows flexible determination of the proportions of the first portion and the second portion in the entire sky scene of the game scene.

In an embodiment, a preset transition effect corresponding to a junction portion between the first portion of the sky background of the game scene rendered based on the current sky background information and the second portion of the sky background of the game scene rendered based on the target sky background information is displayed within the sky background corresponding to the game scene.

The updating of the sky background is implemented to have the preset transition effect, which shows the dynamic transition effect of the sky background update to the player, thereby making the sky background updating process more natural.

In an embodiment, the method further includes, prior to responding to the sky background switching event: controlling, in response to a control command for a controlled virtual object corresponding to the terminal device, the controlled virtual object to execute a first game action satisfying a first preset condition; and triggering the sky background switching event. The method further includes, prior to responding to the sky background update-pausing event: controlling, in response to the control command for the controlled virtual object corresponding to the terminal device, the controlled virtual object to execute a second game action satisfying a second preset condition; and triggering the sky background update-pausing event.

In the aforementioned method, the player may control the switching of the sky background and the pausing of the switching by controlling the movement of the controlled virtual object, thereby enriching gameplay.

In an embodiment, the first game action corresponding to the first preset condition is to control the controlled virtual object to move to a target area within the game scene, and the second game action corresponding to the second preset condition is to control the controlled virtual object to separate from the target area within the game scene.

In the above method, the player may achieve the switching of the sky background and the pausing of the switching by controlling the controlled virtual object to move to the target area and controlling the controlled virtual object to separate from the target area within the game scene, thereby enriching gameplay.

In an embodiment, the aforementioned graphical user interface further displays a switching control and a pause control, the sky background switching event includes triggering of the switching control, and the sky background update-pausing event includes triggering of the pause control.

In this method, the player may trigger the sky background switching event and the sky background update-pausing event respectively via the switching control and the pause control displayed within the graphical user interface, which facilitates the player operation and enriches gameplay.

In an embodiment, the switching parameter includes a switching duration, and updating, based on the switching parameter, the sky background information corresponding to the game scene from the current sky background information to the target sky background information, and dynamically displaying, within the graphical user interface, the dynamically-varying sky background of the game scene rendered during the process of updating the sky background information includes: determining, based on the switching duration, a variation parameter for the sky background information corresponding to unit time during the process of updating the current sky background information corresponding to the game scene to the target sky background information; dynamically updating, based on the variation parameter for the sky background information corresponding to the unit time, the current sky background information, and the target sky background information, the sky background information corresponding to the game scene in chronological order; and dynamically displaying, within the graphical user interface, the dynamically-varying sky background of the game scene rendered based on the sky background information dynamically updated.

In the aforementioned method for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background information is dynamically displayed within the graphical user interface. Concurrently, in this method, the expression of sky background switching is enriched, thereby enhancing the gaming experience of the player.

In an embodiment, the switching parameter further includes a first switching mode, and the sky background information includes a plurality of pixels, and dynamically updating, based on the variation parameter for the sky background information corresponding to the unit time, the current sky background information, and the target sky background information, the sky background information corresponding to the game scene in the chronological order includes: dynamically determining, based on the first switching mode and the variation parameter, a to-be-updated pixel among the plurality of pixels in the sky background information in chronological order, wherein the to-be-updated pixel is a part of the plurality of pixels in the sky background information; determining a target pixel value corresponding to the to-be-updated pixel based on the target sky background information; and updating the pixel value of the to-be-updated pixel from a current pixel value determined based on the current sky background information to the target pixel value.

In an embodiment, the switching parameter further includes a second switching mode, and the sky background information includes a plurality of pixels, and dynamically updating, based on the variation parameter for the sky background information corresponding to the unit time, the current sky background information, and the target sky background information, the sky background information corresponding to the game scene in the chronological order includes: determining, based on the second switching mode, a to-be-updated pixel among the plurality of pixels in the sky background information, wherein the to-be-updated pixel is all pixels among the plurality of pixels in the sky background information; determining a target pixel value corresponding to the to-be-updated pixel based on the target sky background information, and determining a current pixel value corresponding to the to-be-updated pixel based on the current sky background information; and dynamically updating, based on the variation parameter, the target pixel value and the current pixel value, a pixel value of the to-be-updated pixel in chronological order.

In an embodiment, the variation parameter is proportions of the target sky background information and the current sky background information in the sky background information updated.

In an embodiment, that the variation parameter is the proportions of the target sky background information and the current sky background information in the sky background information updated is that the variation parameter is proportions of pixels of the target sky background information and pixels of the current sky background information in pixels of the sky background information updated.

In an embodiment, that the variation parameter is the proportions of the pixels of the target sky background information and the pixels of the current sky background information in the pixels of the sky background information updated includes at least one of: proportions of a pixel value of each pixel in the current sky background information and a pixel value of each pixel in the target sky background information in the sky background information updated; or proportions of a number of pixels in the current sky background information and a number of pixels in the target sky background information in the sky background information updated.

In the aforementioned method for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background method, the expression of sky background switching is enriched, thereby enhancing the gaming experience of the player.

In an embodiment, the switching parameter includes a third switching mode, and the method further includes: switching, based on the third switching mode, the sky background information corresponding to the game scene from the current sky background information to the target sky background information, and continuously displaying, within the graphical user interface, a sky background of the game scene rendered based on the target sky background information.

This method enables the immediate switching of the sky background information corresponding to the game scene to the target sky background information upon triggering the sky background switching event, so that the sky background in the graphical user interface changes instantly from the sky background rendered based on the current sky background information to the sky background rendered based on the target sky background information in a next frame, thereby achieving rapid sky background switching.

In an embodiment, the target sky background information and the switching parameter corresponding to the sky background switching event are determined by: displaying a game editing scene and an editing window within the graphical user interface, wherein the editing window includes a plurality of editable components; generating, in response to a selection operation of a target editable component, a virtual object corresponding to the target editable component within the game editing scene, wherein the virtual object is configured to be displayed using a preset display parameter, and the target editable component is a component of the plurality of editable components; and determining, in response to an editing operation on the target editable component, a switching condition, a switching parameter, and target sky background information corresponding to the target editable component, wherein the switching condition includes a sky background switching event for the target editable component initiating background switching, and a sky background update-pausing event for the target editable component pausing the background switching.

In this method, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, a setting control is displayed within the graphical user interface, and determining, in response to the editing operation on the target editable component, the switching condition, the switching parameter, and the target sky background information corresponding to the target editable component includes: displaying, in response to a trigger operation on the setting control, a parameter setting panel corresponding to the target editable component within the editing window, wherein the parameter setting panel includes a plurality of editable controls, and the editable controls are configured to set the switching condition, the switching parameter, and the target sky background information of the target editable component; determining, in response to a first setting operation on the parameter setting panel, the switching condition corresponding to the target editable component; determining, in response to a second setting parameter on the parameter setting panel, the switching parameter corresponding to the target editable component; and determining, in response to a third setting operation on the parameter setting panel, the target sky background information corresponding to the target editable component.

In this method, the player may freely set the sky background switching event, the sky switching parameter, and the target sky background information corresponding to the target editable component in the game editing scene. This enriches the expression of sky background switching, thereby enhancing the gaming experience of the player.

In an embodiment, the parameter setting panel includes a first editable control configured to set the sky background switching event, and a second editable control configured to set the sky background update-pausing event, and determining, in response to the first setting operation on the parameter setting panel, the switching condition corresponding to the target editable component includes: setting, in response to and based on a first input operation on the first editable control, the sky background switching event corresponding to the target editable component; and setting, in response to and based on a second input operation on the second editable control, the sky background update-pausing event corresponding to the target editable component.

In an embodiment, determining, in response to the third setting operation on the parameter setting panel, the target sky background information corresponding to the target editable component includes: displaying, in response to a trigger operation on the editable control corresponding to the target sky background information within the parameter setting panel, a custom background option and at least one preset sky background texture within the parameter setting panel; and determining, in response to a trigger operation on a first sky background texture of the at least one preset sky background texture, the target sky background information based on the first sky background texture.

In this method, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, the method further includes, after displaying, in response to the trigger operation on the editable control corresponding to the target sky background information within the parameter setting panel, the custom background option and the at least one preset sky background texture within the parameter setting panel: displaying, in response to a trigger operation on the custom background option, a custom setting control within the parameter setting panel; displaying, in response to a trigger operation on the custom setting control, a plurality of preset background parameters within the parameter setting panel; and obtaining, in response to a setting operation on the plurality of preset background parameters, a plurality of target background parameters, and determining the plurality of target background parameters as the target sky background information.

In an embodiment, the preset background parameters include at least one of a first gradient color, a second gradient color, a gradient axis direction, an axis center position, or a gradient contrast.

The custom background option enables the player to personalize the target background parameter, thereby enhancing sense of participation in the game and experience feeling of the player, and improving the flexibility of the sky background within the game scene. Simultaneously, determining the target sky background information based on the plurality of preset background parameters may improve the intuitiveness of parameter setting.

In an embodiment, the parameter setting panel further includes a first interaction control, and the method further includes: displaying, in response to a trigger operation on the first interaction control, the switching parameter set based on the target editable component within the graphical user interface, and during the process of updating the sky background information corresponding to the game scene from the current sky background information to the target sky background information, rendering the sky background of the game scene.

In this method, the player utilizes the preview function provided by the first interaction control to examine whether the sky background switching effect meets his/her requirement.

Furthermore, the electronic device illustrated in FIG. 8 further includes a bus 102 and a communication interface 103, and the processor 101, the communication interface 103, and the memory 100 are interconnected via the bus 102.

The memory 100 may include high-speed random access memory (RAM) and may also include non-volatile memory, such as at least one disk storage device. Communication between this system network element and at least one other network element is achieved via at least one communication interface 103 (which may be wired or wireless), and may use networks such as the internet, wide area networks, local area networks, or metropolitan area networks. The bus 102 may be an ISA bus, PCI bus, or EISA bus, among others. The bus may be divided into address bus, data bus, control bus, etc. For simplicity of representation, FIG. 8 depicts the bus with only a single bidirectional arrow, which however does not imply that there is only one bus or a single bus type.

The processor 101 may be an integrated circuit chip with a signal processing capability. During implementation, the steps of the above method may be implemented through an integrated logic circuit in the hardware form of processor 101 or via instructions in software form. The processor 101 may be a general-purpose processor including a central processing unit (CPU), a network processor (NP), etc., and may also be a digital signal processor (DSP), an application-specific integrated circuit (ASIC), a field-programmable gate array (FPGA) or other programmable logic device, discrete gate or transistor logic devices, or discrete hardware components. It may implement or execute the methods, steps, and logic flowcharts disclosed in the embodiments of the present disclosure. The general-purpose processor may be a microprocessor or any conventional processor. The steps of the method disclosed in the embodiments of the present disclosure may be directly embodied as being executed by a hardware decoding processor, or executed by a combination of hardware and software modules within the decoding processor. The software modules may reside within established storage media in the art, such as random access memory, flash memory, read-only memory, programmable read-only memory, electrically erasable programmable read-only memory, or registers. This storage medium is located within the memory 100, from which the processor 101 reads information to execute the steps of the method described in the foregoing embodiments in conjunction with hardware.

An embodiment of the present disclosure further provides a computer-readable storage medium having computer-executable instructions stored thereon that, when invoked and executed by a processor, cause the processor to implement the method for switching the sky background in the game as described above. Specific implementation details may be found in the method embodiments, which are not be repeated herein.

Specifically, a graphical user interface is provided via a terminal device and displays a portion of a game scene and a sky background corresponding to the game scene, and the sky background is a background generated based on sky background information. The method for switching the sky background in the game includes: determining, in response to a sky background switching event, target sky background information and a switching parameter corresponding to the sky background switching event; and updating, based on the switching parameter, the sky background information corresponding to the game scene from current sky background information to the target sky background information, and dynamically displaying, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

In the method for switching the sky background in the game, a player may achieve switching of the sky background corresponding to the game scene during a gameplay by triggering the sky background switching event. Concurrently, in this method, the expression of sky background switching is enriched through the switching parameter, thereby enhancing the gaming experience of the player.

In an embodiment, the process of updating the sky background information continues for a preset duration.

The process of updating the sky background information continues for the preset duration, so that the process of updating the sky background may be dynamically displayed within the graphical user interface, which allows a player to intuitively observe a varying sky background of the game scene that is varying by adjusting a game perspective.

In an embodiment, the method further includes, prior to determining, in response to the sky background switching event, the target sky background information and the switching parameter corresponding to the sky background switching event: controlling, in response to a game start command, the graphical user interface to display a game scene corresponding to a gameplay.

By triggering the game start command to display the game scene corresponding to the gameplay within the graphical user interface, the game perspective may be focused on the current gameplay as a controlled virtual object is within a game level or gameplay, which facilitates subsequent operations of the player.

In an embodiment, the aforementioned game scene includes a skybox, the sky background information is attribute information corresponding to the skybox, and the sky background is a background generated based on sky background information of the skybox.

The skybox may encompass the entire game scene and provide the sky background for the game scene based on the sky background information, which facilitates subsequent rapid updating of the entire sky background information corresponding to the game scene from the current sky background information to the target sky background information. In an embodiment, the aforementioned method further includes: during the process of updating the sky background information, pausing, in response to a sky background update-pausing event, the process of updating the sky background information, and continuously displaying, within the graphical user interface, a sky background of the game scene rendered based on sky background information corresponding to a time when responding to the sky background update-pausing event.

During the process of updating the sky background information, a user may trigger the sky background update-pausing event in real-time to display the sky background of the game scene rendered based on the sky background information corresponding to the time of the occurrence of the update-pausing event, which facilitates the player to flexibly control the entire sky background updating process within the game scene.

In an embodiment, the aforementioned sky background of the game scene rendered based on the sky background information corresponding to the time when responding to the sky background update-pausing event includes a sky background formed by a first portion of a sky background of the game scene rendered based on the current sky background information and a second portion of a sky background of the game scene rendered based on the target sky background information.

As the sky background update-pausing event occurs at any point during the process of updating the sky background information corresponding to the game scene from the current sky background information to the target sky background information, the sky background is typically formed of the first portion of the sky background of the game scene rendered based on the current sky background information and the second portion of the sky background of the game scene rendered based on the target sky background information, which facilitates the player to flexibly control the entire sky background updating process within the game scene. Specifically, the timing at which the player triggers the sky background update-pausing event allows flexible determination of the proportions of the first portion and the second portion in the entire sky scene of the game scene.

In an embodiment, a preset transition effect corresponding to a junction portion between the first portion of the sky background of the game scene rendered based on the current sky background information and the second portion of the sky background of the game scene rendered based on the target sky background information is displayed within the sky background corresponding to the game scene.

The updating of the sky background is implemented to have the preset transition effect, which shows the dynamic transition effect of the sky background update to the player, thereby making the sky background updating process more natural.

In an embodiment, the method further includes, prior to responding to the sky background switching event: controlling, in response to a control command for a controlled virtual object corresponding to the terminal device, the controlled virtual object to execute a first game action satisfying a first preset condition; and triggering the sky background switching event. The method further includes, prior to responding to the sky background update-pausing event: controlling, in response to the control command for the controlled virtual object corresponding to the terminal device, the controlled virtual object to execute a second game action satisfying a second preset condition; and triggering the sky background update-pausing event.

In the aforementioned method, the player may control the switching of the sky background and the pausing of the switching by controlling the movement of the controlled virtual object, thereby enriching gameplay.

In an embodiment, the first game action corresponding to the first preset condition is to control the controlled virtual object to move to a target area within the game scene, and the second game action corresponding to the second preset condition is to control the controlled virtual object to separate from the target area within the game scene.

In the above method, the player may achieve the switching of the sky background and the pausing of the switching by controlling the controlled virtual object to move to the target area and controlling the controlled virtual object to separate from the target area within the game scene, thereby enriching gameplay.

In an embodiment, the aforementioned graphical user interface further displays a switching control and a pause control, the sky background switching event includes triggering of the switching control, and the sky background update-pausing event includes triggering of the pause control.

In this method, the player may trigger the sky background switching event and the sky background update-pausing event respectively via the switching control and the pause control displayed within the graphical user interface, which facilitates the player operation and enriches gameplay.

In an embodiment, the switching parameter includes a switching duration, and updating, based on the switching parameter, the sky background information corresponding to the game scene from the current sky background information to the target sky background information, and dynamically displaying, within the graphical user interface, the dynamically-varying sky background of the game scene rendered during the process of updating the sky background information includes: determining, based on the switching duration, a variation parameter for the sky background information corresponding to unit time during the process of updating the current sky background information corresponding to the game scene to the target sky background information; dynamically updating, based on the variation parameter for the sky background information corresponding to the unit time, the current sky background information, and the target sky background information, the sky background information corresponding to the game scene in chronological order; and dynamically displaying, within the graphical user interface, the dynamically-varying sky background of the game scene rendered based on the sky background information dynamically updated.

In the aforementioned method for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background information is dynamically displayed within the graphical user interface. Concurrently, in this method, the expression of sky background switching is enriched, thereby enhancing the gaming experience of the player.

In an embodiment, the switching parameter further includes a first switching mode, and the sky background information includes a plurality of pixels, and dynamically updating, based on the variation parameter for the sky background information corresponding to the unit time, the current sky background information, and the target sky background information, the sky background information corresponding to the game scene in the chronological order includes: dynamically determining, based on the first switching mode and the variation parameter, a to-be-updated pixel among the plurality of pixels in the sky background information in chronological order, wherein the to-be-updated pixel is a part of the plurality of pixels in the sky background information; determining a target pixel value corresponding to the to-be-updated pixel based on the target sky background information; and updating the pixel value of the to-be-updated pixel from a current pixel value determined based on the current sky background information to the target pixel value.

In an embodiment, the switching parameter further includes a second switching mode, and the sky background information includes a plurality of pixels, and dynamically updating, based on the variation parameter for the sky background information corresponding to the unit time, the current sky background information, and the target sky background information, the sky background information corresponding to the game scene in the chronological order includes: determining, based on the second switching mode, a to-be-updated pixel among the plurality of pixels in the sky background information, wherein the to-be-updated pixel is all pixels among the plurality of pixels in the sky background information; determining a target pixel value corresponding to the to-be-updated pixel based on the target sky background information, and determining a current pixel value corresponding to the to-be-updated pixel based on the current sky background information; and dynamically updating, based on the variation parameter, the target pixel value and the current pixel value, a pixel value of the to-be-updated pixel in chronological order.

In an embodiment, the variation parameter is proportions of the target sky background information and the current sky background information in the sky background information updated.

In an embodiment, that the variation parameter is the proportions of the target sky background information and the current sky background information in the sky background information updated is that the variation parameter is proportions of pixels of the target sky background information and pixels of the current sky background information in pixels of the sky background information updated.

In an embodiment, that the variation parameter is the proportions of the pixels of the target sky background information and the pixels of the current sky background information in the pixels of the sky background information updated includes at least one of: proportions of a pixel value of each pixel in the current sky background information and a pixel value of each pixel in the target sky background information in the sky background information updated; or proportions of a number of pixels in the current sky background information and a number of pixels in the target sky background information in the sky background information updated.

In the aforementioned method for switching the sky background in the game, during the gameplay of the player, the sky background switching event may be triggered, the sky background information corresponding to the game scene is dynamically updated to the target sky background information based on the switching mode and the switching duration corresponding to the sky background switching event, and the dynamically-varying sky background of the game scene rendered based on the dynamically updated sky background method, the expression of sky background switching is enriched, thereby enhancing the gaming experience of the player.

In an embodiment, the switching parameter includes a third switching mode, and the method further includes: switching, based on the third switching mode, the sky background information corresponding to the game scene from the current sky background information to the target sky background information, and continuously displaying, within the graphical user interface, a sky background of the game scene rendered based on the target sky background information.

This method enables the immediate switching of the sky background information corresponding to the game scene to the target sky background information upon triggering the sky background switching event, so that the sky background in the graphical user interface changes instantly from the sky background rendered based on the current sky background information to the sky background rendered based on the target sky background information in a next frame, thereby achieving rapid sky background switching.

In an embodiment, the target sky background information and the switching parameter corresponding to the sky background switching event are determined by: displaying a game editing scene and an editing window within the graphical user interface, wherein the editing window includes a plurality of editable components; generating, in response to a selection operation of a target editable component, a virtual object corresponding to the target editable component within the game editing scene, wherein the virtual object is configured to be displayed using a preset display parameter, and the target editable component is a component of the plurality of editable components; and determining, in response to an editing operation on the target editable component, a switching condition, a switching parameter, and target sky background information corresponding to the target editable component, wherein the switching condition includes a sky background switching event for the target editable component initiating background switching, and a sky background update-pausing event for the target editable component pausing the background switching.

In this method, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, a setting control is displayed within the graphical user interface, and determining, in response to the editing operation on the target editable component, the switching condition, the switching parameter, and the target sky background information corresponding to the target editable component includes: displaying, in response to a trigger operation on the setting control, a parameter setting panel corresponding to the target editable component within the editing window, wherein the parameter setting panel includes a plurality of editable controls, and the editable controls are configured to set the switching condition, the switching parameter, and the target sky background information of the target editable component; determining, in response to a first setting operation on the parameter setting panel, the switching condition corresponding to the target editable component; determining, in response to a second setting parameter on the parameter setting panel, the switching parameter corresponding to the target editable component; and determining, in response to a third setting operation on the parameter setting panel, the target sky background information corresponding to the target editable component.

In this method, the player may freely set the sky background switching event, the sky switching parameter, and the target sky background information corresponding to the target editable component in the game editing scene. This enriches the expression of sky background switching, thereby enhancing the gaming experience of the player.

In an embodiment, the parameter setting panel includes a first editable control configured to set the sky background switching event, and a second editable control configured to set the sky background update-pausing event, and determining, in response to the first setting operation on the parameter setting panel, the switching condition corresponding to the target editable component includes: setting, in response to and based on a first input operation on the first editable control, the sky background switching event corresponding to the target editable component; and setting, in response to and based on a second input operation on the second editable control, the sky background update-pausing event corresponding to the target editable component.

In an embodiment, determining, in response to the third setting operation on the parameter setting panel, the target sky background information corresponding to the target editable component includes: displaying, in response to a trigger operation on the editable control corresponding to the target sky background information within the parameter setting panel, a custom background option and at least one preset sky background texture within the parameter setting panel; and determining, in response to a trigger operation on a first sky background texture of the at least one preset sky background texture, the target sky background information based on the first sky background texture.

In this method, the player may freely set the sky background switching event, the sky background update-pausing event, the switching parameter, and the target sky background information corresponding to the target editable component in the game editing scene. This enriches the expression of sky background switching, thereby enhancing the gaming experience of the player.

In an embodiment, the method further includes, after displaying, in response to the trigger operation on the editable control corresponding to the target sky background information within the parameter setting panel, the custom background option and the at least one preset sky background texture within the parameter setting panel: displaying, in response to a trigger operation on the custom background option, a custom setting control within the parameter setting panel; displaying, in response to a trigger operation on the custom setting control, a plurality of preset background parameters within the parameter setting panel; and obtaining, in response to a setting operation on the plurality of preset background parameters, a plurality of target background parameters, and determining the plurality of target background parameters as the target sky background information.

In an embodiment, the preset background parameters include at least one of a first gradient color, a second gradient color, a gradient axis direction, an axis center position, or a gradient contrast.

The custom background option enables the player to personalize the target background parameter, thereby enhancing sense of participation in the game and experience feeling of the player, and improving the flexibility of the sky background within the game scene. Simultaneously, determining the target sky background information based on the plurality of preset background parameters may improve the intuitiveness of parameter setting.

In an embodiment, the parameter setting panel further includes a first interaction control, and the method further includes: displaying, in response to a trigger operation on the first interaction control, the switching parameter set based on the target editable component within the graphical user interface, and during the process of updating the sky background information corresponding to the game scene from the current sky background information to the target sky background information, rendering the sky background of the game scene.

In this method, the player utilizes the preview function provided by the first interaction control to examine whether the sky background switching effect meets his/her requirement.

If the function is implemented as a software function unit and sold or used as an independent product, it may be stored on a computer-readable storage medium. Based on such understanding, the technical solution of the present disclosure or a portion thereof that constitutes an essential contribution to the prior art may be embodied as a software product. The computer software product is stored on a storage medium and includes a plurality of instructions for causing a computer device (which may be a personal computer, terminal device, or network device, etc.) to execute all or part of the steps of the methods described in the various embodiments of the present disclosure. The above storage medium includes: USB flash drives, portable hard drives, read-only memory (ROM), random access memory (RAM), magnetic disks, optical discs, and other media capable of storing program codes.

In the description of the present disclosure, it should be noted that the orientations and position relationships indicated by the terms “center”, “up”, “down”, “left”, “right”, “vertical”, “horizontal”, “inside”, “outside”, and the like are based on the orientations or position relationships shown in the accompanying drawings, which are used solely for the purpose of facilitating the description of the present disclosure and simplifying the description, and are not intended to indicate or imply that a device or element referred to must possess a specific orientation, and be constructed and operated in a specific orientation. Therefore, they should not be construed as limitations on the present disclosure. Furthermore, the terms “first”, “second”, and ‘third’ are employed solely for descriptive purposes and should not be construed as indicating or implying relative importance.

Finally, it should be noted that the above embodiments represent specific implementations of the present disclosure and are intended to illustrate the technical solutions of the present disclosure but not to constitute limitations thereon, and the protection scope of the present disclosure is not limited to these embodiments.

Although the present disclosure has been described in detail with reference to the foregoing embodiments, a person skilled in the art may understand that: any person skilled in the art, within the technology scope disclosed by the present disclosure, may modify the technical solutions described in the foregoing embodiments or readily conceive of variations thereof, or replace some technical features thereof with equivalent features. Such modifications, variations, or replacements do not make the corresponding technical solution depart from the spirit and scope of the technical solutions of the present disclosure and should fall within the protection scope of the present disclosure. Therefore, the protection scope of the present disclosure shall be determined by the claims.

1. A method for switching a sky background in a game, wherein a graphical user interface is provided via a terminal device and displays a portion of a game scene and a sky background corresponding to the game scene, and the sky background is a background generated based on sky background information, and the method comprises:
determining, in response to a sky background switching event, target sky background information and a switching parameter corresponding to the sky background switching event; and
updating, based on the switching parameter, the sky background information corresponding to the game scene from current sky background information to the target sky background information, and dynamically displaying, within the graphical user interface, a dynamically-varying sky background of the game scene rendered during a process of updating the sky background information, wherein the process of updating the sky background information is a process of updating the sky background information corresponding to the game scene from the current sky background information to the target sky background information.

2. (canceled)

3. The method according to claim 1, further comprising:
controlling, in response to a game start command, the graphical user interface to display a game scene corresponding to a gameplay.

4. The method according to claim 1, wherein the game scene comprises a skybox, the sky background information is attribute information corresponding to the skybox, and the sky background is a background generated based on sky background information of the skybox.

5. The method according to claim 1, further comprising:
during the process of updating the sky background information, pausing, in response to a sky background update-pausing event, the process of updating the sky background information, and continuously displaying, within the graphical user interface, a sky background of the game scene rendered based on sky background information corresponding to a time when responding to the sky background update-pausing event.

6. The method according to claim 5, wherein the sky background of the game scene rendered based on the sky background information corresponding to the time when responding to the sky background update-pausing event comprises a sky background formed by a first portion of a sky background of the game scene rendered based on the current sky background information and a second portion of a sky background of the game scene rendered based on the target sky background information.

7. The method according to claim 6, wherein a preset transition effect corresponding to a junction portion between the first portion of the sky background of the game scene rendered based on the current sky background information and the second portion of the sky background of the game scene rendered based on the target sky background information is displayed within the sky background corresponding to the game scene.

8. The method according to claim 5, further comprising:
controlling, in response to a control command for a controlled virtual object corresponding to the terminal device, the controlled virtual object to execute a first game action satisfying a first preset condition; and
triggering the sky background switching event,
wherein the method further comprises:
controlling, in response to the control command for the controlled virtual object corresponding to the terminal device, the controlled virtual object to execute a second game action satisfying a second preset condition; and
triggering the sky background update-pausing event.

9. The method according to claim 8, wherein the first game action corresponding to the first preset condition is to control the controlled virtual object to move to a target area within the game scene, and the second game action corresponding to the second preset condition is to control the controlled virtual object to separate from the target area within the game scene.

10. The method according to claim 5, wherein the graphical user interface further displays a switching control and a pause control, the sky background switching event comprises triggering of the switching control, and the sky background update-pausing event comprises triggering of the pause control.

11. The method according to claim 1, wherein the switching parameter comprises a switching duration, and updating, based on the switching parameter, the sky background information corresponding to the game scene from the current sky background information to the target sky background information, and dynamically displaying, within the graphical user interface, the dynamically-varying sky background of the game scene rendered during the process of updating the sky background information comprises:
determining, based on the switching duration, a variation parameter for the sky background information corresponding to unit time during the process of updating the current sky background information corresponding to the game scene to the target sky background information;
dynamically updating, based on the variation parameter for the sky background information corresponding to the unit time, the current sky background information, and the target sky background information, the sky background information corresponding to the game scene in chronological order; and
dynamically displaying, within the graphical user interface, the dynamically-varying sky background of the game scene rendered based on the sky background information dynamically updated.

12. The method according to claim 11, wherein the switching parameter further comprises a first switching mode, and the sky background information comprises a plurality of pixels,
wherein dynamically updating, based on the variation parameter for the sky background information corresponding to the unit time, the current sky background information, and the target sky background information, the sky background information corresponding to the game scene in the chronological order comprises:
dynamically determining, based on the first switching mode and the variation parameter, a to-be-updated pixel among the plurality of pixels in the sky background information in chronological order, wherein the to-be-updated pixel comprises a part of the plurality of pixels in the sky background information;
determining a target pixel value corresponding to the to-be-updated pixel based on the target sky background information; and
updating the pixel value of the to-be-updated pixel from a current pixel value determined based on the current sky background information to the target pixel value.

13. The method according to claim 11, wherein the switching parameter further comprises a second switching mode, and the sky background information comprises a plurality of pixels,
wherein dynamically updating, based on the variation parameter for the sky background information corresponding to the unit time, the current sky background information, and the target sky background information, the sky background information corresponding to the game scene in the chronological order comprises:
determining, based on the second switching mode, a to-be-updated pixel among the plurality of pixels in the sky background information, wherein the to-be-updated pixel is all pixels among the plurality of pixels in the sky background information;
determining a target pixel value corresponding to the to-be-updated pixel based on the target sky background information, and determining a current pixel value corresponding to the to-be-updated pixel based on the current sky background information; and
dynamically updating, based on the variation parameter, the target pixel value and the current pixel value, a pixel value of the to-be-updated pixel in chronological order.

14. The method according to claim 11, wherein the variation parameter is proportions of the target sky background information and the current sky background information in the sky background information updated.

15. The method according to claim 14, wherein the proportions of the target sky background information and the current sky background information in the sky background information updated is proportions of pixels of the target sky background information and pixels of the current sky background information in pixels of the sky background information updated.

16. The method according to claim 15, wherein the proportions of the pixels of the target sky background information and the pixels of the current sky background information in the pixels of the sky background information updated comprises at least one of:
proportions of a pixel value of each pixel in the current sky background information and a pixel value of each pixel in the target sky background information in the sky background information updated; or
proportions of a number of pixels in the current sky background information and a number of pixels in the target sky background information in the sky background information updated.

17. The method according to claim 1, wherein the switching parameter comprises a third switching mode, and the method further comprises:
switching, based on the third switching mode, the sky background information corresponding to the game scene from the current sky background information to the target sky background information, and continuously displaying, within the graphical user interface, a sky background of the game scene rendered based on the target sky background information.

18. The method according to claim 3, wherein the target sky background information and the switching parameter corresponding to the sky background switching event are determined by:
displaying a game editing scene and an editing window within the graphical user interface, wherein the editing window comprises a plurality of editable components;
generating, in response to a selection operation of a target editable component, a virtual object corresponding to the target editable component within the game editing scene, wherein the virtual object is configured to be displayed using a preset display parameter, and the target editable component is a component of the plurality of editable components; and
determining, in response to an editing operation on the target editable component, a switching condition, a switching parameter, and target sky background information corresponding to the target editable component, wherein the switching condition comprises a sky background switching event for the target editable component initiating background switching, and a sky background update-pausing event for the target editable component pausing the background switching.

19. The method according to claim 18, wherein a setting control is displayed within the graphical user interface,
determining, in response to the editing operation on the target editable component, the switching condition, the switching parameter, and the target sky background information corresponding to the target editable component comprises:
displaying, in response to a trigger operation on the setting control, a parameter setting panel corresponding to the target editable component within the editing window, wherein the parameter setting panel comprises a plurality of editable controls, and the editable controls are configured to set the switching condition, the switching parameter, and the target sky background information of the target editable component;
determining, in response to a first setting operation on the parameter setting panel, the switching condition corresponding to the target editable component;
determining, in response to a second setting operation on the parameter setting panel, the switching parameter corresponding to the target editable component; and
determining, in response to a third setting operation on the parameter setting panel, the target sky background information corresponding to the target editable component.

20-25. (canceled)

26. An electronic device comprising a processor and a memory, wherein the memory stores machine-executable instructions executable by the processor, and the processor executes the machine-executable instructions to implement actions comprising:
determining, in response to a sky background switching event, target sky background information and a switching parameter corresponding to the sky background switching event; and
updating, based on the switching parameter, the sky background information corresponding to the game scene from current sky background information to the target sky background information, and dynamically displaying, within a graphical user interface provided by a terminal device, a dynamically-varying sky background of the game scene rendered during a process of updating the sky background information, wherein the process of updating the sky background information is a process of updating the sky background information corresponding to the game scene from the current sky background information to the target sky background information.

27. A computer-readable storage medium having computer-executable instructions stored thereon that, when invoked and executed by a processor, cause the processor to implement actions comprising:
determining, in response to a sky background switching event, target sky background information and a switching parameter corresponding to the sky background switching event; and
updating, based on the switching parameter, the sky background information corresponding to the game scene from current sky background information to the target sky background information, and dynamically displaying, within a graphical user interface provided by a terminal device, a dynamically-varying sky background of the game scene rendered during a process of updating the sky background information, wherein the process of updating the sky background information is a process of updating the sky background information corresponding to the game scene from the current sky background information to the target sky background information.
